(19) United States
(12) Patent Application Publication
(10) Pub. No.: US 2017/0335202 A1
(43) Pub. Date: Nov. 23, 2017

(54) NANOCATALYST FOR FISCHER-TROPSCH SYNTHESIS AND METHODS FOR PREPARING AND USING THE SAME

(71) Applicant: Wuhan Kaidi Engineering Technology Research Institute Co., Ltd., Wuhan (CN)

(72) Inventors: Yilong CHEN, Wuhan (CN); Shenke ZHENG, Wuhan (CN); Jiangang CHEN, Wuhan (CN); Dechen SONG, Wuhan (CN); Xiaodong ZHAN, Wuhan (CN); Yanfeng ZHANG, Wuhan (CN)

(21) Appl. No.: 15/662,310

(22) Filed: Jul. 28, 2017

Related U.S. Application Data
(63) Continuation-in-part of application No. PCT/CN2016/072081, filed on Jan. 26, 2016.

(30) Foreign Application Priority Data
Jan. 30, 2015 (CN) 201510050801.3

(51) Int. Cl. C10G 2/00; B01J 23/75; B01J 31/02; B01J 37/00; B01J 23/745; B01J 35/00; B01J 35/12; B01J 37/04

(52) U.S. Cl. CPC C10G 2/332; B01J 35/12; B01J 23/75; B01J 37/04; B01J 37/0072; B01J 23/745; B01J 35/0013; B01J 31/02; B01J 2231/62; B01J 2531/005

(57) ABSTRACT

A catalyst, including: a transition metal; and an organic solvent. The transition metal is dispersed in the organic solvent in the form of monodisperse nanoparticles; the transition metal has a grain size of between 1 and 100 nm; and the catalyst has a specific surface area of 5 and 300 m²/g. The invention also provides a method for preparing a catalyst, including: 1) dissolving an organic salt of a transition metal in an organic solvent including a polyhydric alcohol, to yield a mixture; and 2) heating and stirring the mixture in the presence of air or inert gas, holding the mixture at the temperature of between 150 and 250° C. for between 30 and 240 min, to yield the catalyst.

### CROSS-REFERENCE TO RELATED APPLICATIONS

This application is a continuation-in-part of International Patent Application No. PCT/CN2016/072081 with an international filing date of Jan. 26, 2016, designating the United States, now pending, and further claims priority to Chinese Patent Application No. 201510050801.3 filed Jan. 30, 2015. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

### Field of the Invention

The invention relates to a monodisperse nano-metal catalyst for Fischer-Tropsch synthesis, a preparation method and use thereof.

### Description of the Related Art

Fischer-Tropsch synthesis (F-T synthesis) is a collection of chemical reactions that converts a mixture of carbon monoxide and hydrogen into liquid hydrocarbons. F-T synthesis involves a series of catalysts.

Studies show that the catalytic activity and selectivity of F-T catalysts are closely related to the grain size of the metal particles of the catalysts. However, conventional preparation methods fail to adequately control the grain size thereof.

### SUMMARY OF THE INVENTION

In view of the above-described problems, it is one objective of the invention to provide a monodisperse transition metal nanocatalyst for Fischer-Tropsch synthesis, a method of preparing the nanocatalyst and a method of using the nanocatalyst.

The preparation method can effectively control the grain size of the active metal of the catalyst, and the resulting catalysts exhibit relatively high catalytic activity and product selectivity.

To achieve the above objective, in accordance with one embodiment of the invention, there is provided a catalyst, comprising a transition metal and an organic solvent. The transition metal is dispersed in the organic solvent in the form of monodisperse nanoparticles. The dispersion is stable. The transition metal has a grain size of between 1 and 100 nm; and the catalyst has a specific surface area of 5 and 300 m²/g.

In a class of this embodiment, the transition metal is manganese, iron, cobalt, ruthenium, or a mixture thereof.

In a class of this embodiment, the organic solvent is benzyl ether, aromatic alcohol, pyrrolidone, or liquid paraffin.

In a class of this embodiment, the grain size of the transition metal is between 5 and 20 nm

In another aspect, the present disclosure also provides a method for preparing the catalyst, the method comprising:
1) dissolving an organic salt of the transition metal into the organic solvent comprising a polyhydric alcohol, to yield a mixture; and
2) heating and stiffing the mixture in the presence of air or inert gas, holding the mixture at a temperature of between 150 and 250° C. for between 30 and 240 min, to yield the monodisperse transition metal nanocatalyst for Fischer-Tropsch synthesis.

In a class of this embodiment, in 1), the transition metal is manganese, iron, cobalt, ruthenium, or a mixture thereof, and the organic salt is oxalate, acetylacetonate, or carbonyl metal salt.

In a class of this embodiment, in 1), the polyhydric alcohol is C₃-C₁₈ dihydric alcohol or trihydric alcohol, and the organic solvent is benzyl ether, aromatic alcohol, pyrrolidone, or liquid paraffin.

In a class of this embodiment, in 1), a molar ratio of the polyhydric alcohol to the organic salt of the transition metal is between 1-5:1, and a molar ratio of the organic solvent to the organic salt of the transition metal is between 30-500:1.

In a class of this embodiment, in 2), a heating rate of the mixture is between 1 and 10° C./min, and a holding time of the temperature is between 60 and 120 min.

The present disclosure further provides a method for Fischer-Tropsch synthesis comprising applying the monodisperse transition metal nanocatalyst of claim 1, the method comprising, without filtration, separation, cleaning, high temperature roasting and activation reduction, directly employing the catalyst for the Fischer-Tropsch synthesis, and controlling a reaction temperature of between 180 and 300° C., a reaction pressure of between 1 and 3 megapascal, a feed volume ratio of hydrogen to carbon monoxide of between 1 and 2.5, and a total space velocity of between 0.5 and 15 L/h/g catalyst.

Advantages of the monodisperse transition metal nanocatalyst for Fischer-Tropsch synthesis according to embodiments of the invention are summarized as follows:
First, the catalyst of the present disclosure is a non-loaded nano metal particle catalyst, the nano metal particle can move freely in the reaction process, no need to attach to the surface of the carrier, thus increasing the specific surface area and enhancing the catalytic properties of the catalyst. In addition, the nano metal particles have high concentration.
Second, the grain size of the active component particles is adjustable, so the size of the metal nanoparticles is controllable.
Third, the preparation method of the invention is simple and easy to operate, environment friendly, can adjust the grain size of the metal nanoparticles; in the meanwhile, the active component is stably dispersed in the organic solvent in the form of monodisperse nanoparticles, and the disperse solvent is recyclable.
Fourth, the nano metal particles of the catalyst have high dispersity, in a slurry reactor, without involving filtration, separation, cleaning, high temperature roasting and activation reduction, the catalyst can be directly used for Fischer-Tropsch synthesis, and exhibits excellent catalytic properties and product selectivity.

### BRIEF DESCRIPTION OF THE DRAWINGS

The invention is described hereinbelow with reference to accompanying drawings, in which the sole figure is an image of a catalyst for Fischer-Tropsch synthesis under transmission electron microscope in Example 1 of the invention.

### DETAILED DESCRIPTION OF THE EMBODIMENTS

For further illustrating the invention, experiments detailing a catalyst for Fischer-Tropsch synthesis, a preparation method and use thereof are described hereinbelow combined with the drawings. It should be noted that the following examples are intended to describe and not to limit the invention.

### EXAMPLE 1

6 g of iron (III) acetylacetonate was dissolved in 550 mL of 2-pyrrolidone (having a density of 1.116 g/mL), followed by addition of 3.5 g of 1,2-dihydroxydodecane, to yield a mixture. Thereafter, in the presence of mechanical stirring and air, the solution was heated to the temperature of 160° C. with a heating rate of 1° C./min. The solution was held for 120 min at the temperature of 160° C., and then cooled to room temperature, to yield a grey black nano iron colloid solution, which was sealed using 250 mL of liquid paraffin for use.

The prepared grey black nano iron colloid solution, together with the liquid paraffin, was transferred to a slurry bed reactor for Fischer-Tropsch synthesis immediately. The reaction temperature was 260° C., the feed volume ratio of hydrogen to carbon monoxide was 1.2, the gas space velocity was 13.7 L/h/g catalyst (the gas flow velocity was 13 L/h), and the reaction pressure was 2 MPa.

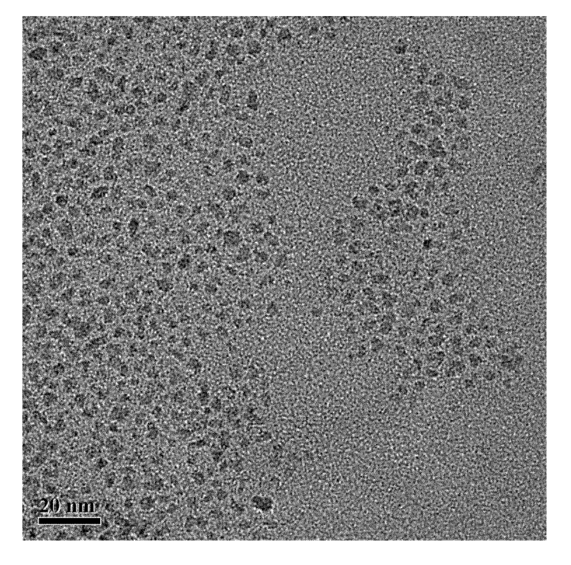

Under the conditions, the performance evaluation of the catalyst is listed in Table 1, and the microstructure of the catalyst is shown in FIG. 1.

TABLE 1

| | | Catalysts of the invention | | | |
|---|---|---|---|---|---|
| | | Exam- | Exam- | Exam- | Exam- |
| Parameters | | ple 1 | ple 2 | ple 3 | ple 4 |
| Physico- | Average grain size | 5.3 | 47.0 | 18.7 | 83.3 |
| chemical | of metal crystal | | | | |
| properties | (nm) | | | | |
| | Specific surface | 288.3 | 17.4 | 54.1 | 8.6 |
| | area of catalysts | | | | |
| | (m²/g) | | | | |
| Evalua- | Reaction | 260 | 180 | 200 | 240 |
| tion index | temperature (° C.) | | | | |
| | Reaction pressure | 2 | 3 | 1 | 2 |
| | (MPa) | | | | |
| | Feed volume ratio | 1.2 | 2.4 | 2 | 1.8 |
| | of hydrogen to | | | | |
| | carbon monoxide | | | | |
| | Space velocity | 13.7 | 4.8 | 7.3 | 0.8 |
| | (L/h/g catalyst) | | | | |
| Catalytic | CO conversion (%) | 73.2 | 26.7 | 33.1 | 32.8 |
| properties | Methane selectivity | 3.2 | 7.7 | 6.1 | 2.8 |
| | (mol %) | | | | |
| | Carbon dioxide | 21.4 | 0.5 | 4.2 | 26.4 |
| | selectivity (mol %) | | | | |
| | C₂₋₄ hydrocarbon | 23.6 | 16.3 | 19 | 22.9 |
| | selectivity (mol %) | | | | |
| | C₅+ hydrocarbon | 51.8 | 75.5 | 70.7 | 47.9 |
| | selectivity (mol %) | | | | |

The data in the table was obtained by statistical analysis of images from transmission electron microscopy.

### EXAMPLE 2

2.6 g of cobalt oxalate (II) and 0.01 g of ruthenium nitrosyl nitrate (III) was dissolved in 250 mL of dibenzyl ether (having a density of 1.04 g/mL), followed by addition of 10 g of 1,2-hexadecanediol, to yield a mixture. Thereafter, in the presence of mechanical stiffing and argon gas, the solution was heated to the temperature of 250° C. with a heating rate of 10° C. /min The solution was held for 80 min at the temperature of 250° C., and then cooled to room temperature, to yield a dark purple nano cobalt colloid solution, which was sealed using 250 mL of liquid paraffin for use.

The prepared dark purple nano cobalt colloid solution, together with the liquid paraffin, was transferred to a slurry bed reactor for Fischer-Tropsch synthesis immediately. The reaction temperature was 180° C., the feed volume ratio of hydrogen to carbon monoxide was 2.4, the gas space velocity was 4.8 L/h/g catalyst (the gas flow velocity was 5 L/h), and the reaction pressure was 3 MPa. Under the conditions, the performance evaluation of the catalyst is listed in Table 1.

### EXAMPLE 3

4 g of iron (III) acetylacetonate and 2 g of cobalt acetylacetonate (II) was dissolved in 450 mL of benzyl alcohol (having a density of 1.04 g/mL), followed by addition of 9 g of 1,2,4-butanetriol, to yield a mixture. Thereafter, in the presence of mechanical stiffing and air, the solution was heated to the temperature of 200° C. with a heating rate of 5° C./min. The solution was held for 60 min at the temperature of 200° C., and then cooled to room temperature, to yield a dark grey nano ferrocobalt colloid solution, which was sealed using 250 mL of liquid paraffin for use.

The prepared dark grey nano ferrocobalt colloid solution, together with the liquid paraffin, was transferred to a slurry bed reactor for Fischer-Tropsch synthesis immediately. The reaction temperature was 200° C., the feed volume ratio of hydrogen to carbon monoxide was 2, the gas space velocity was 7.3 L/h/g catalyst (the gas flow velocity was 8 L/h), and the reaction pressure was 1 MPa. Under the conditions, the performance evaluation of the catalyst is listed in Table 1.

### EXAMPLE 4

3.1 g of pentacarbonyl iron and 2.6 g of decacarbonyldimanganese were dissolved in 250 mL of liquid paraffin (having a density of 0.87 g/mL), followed by addition of 5 g of 1,2,8-octanetriol, to yield a mixture. Thereafter, in the presence of mechanical stiffing and nitrogen, the solution was heated to the temperature of 235° C. with a heating rate of 8° C. /min. The solution was held for 100 min at the temperature of 235° C., and then cooled to room temperature, to yield a grey black nano ferrimanganic colloid solution, which was sealed for use.

The prepared grey black nano ferrimanganic colloid solution was transferred to a slurry bed reactor for Fischer-Tropsch synthesis immediately. The reaction temperature was 240° C., the feed volume ratio of hydrogen to carbon monoxide was 1.8, the gas space velocity was 0.8 L/h/g catalyst (the gas flow velocity was 1 L/h), and the reaction pressure was 2 MPa. Under the conditions, the performance evaluation of the catalyst is listed in Table 1.

Based on the physico-chemical properties and catalytic properties of the catalyst as shown in Table 1, the preparation method of the present disclosure can quickly produce high activity metal nanometer particle catalyst with different grain sizes. In general, the smaller the grain size of the catalyst, the bigger the active specific surface area, and the higher the catalytic activity. However, the stability of the catalyst will decrease. The nano-metal catalyst having the grain size of 5-20 nm exhibits better comprehensive properties. Compared with conventional industrial catalysts, the catalyst of the invention exhibits better catalytic activity, lower methane selectivity, higher selectivity for C₂₋₄ hydrocarbons, so the catalyst of the invention has better application prospect.

Unless otherwise indicated the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A catalyst, comprising:
a transition metal; and
an organic solvent;
wherein
the transition metal is dispersed in the organic solvent in the form of monodisperse nanoparticles;
the transition metal has a grain size of between 1 and 100 nm; and
the catalyst has a specific surface area of 5 and 300 m2/g.

2. The catalyst of claim 1, wherein the transition metal is manganese, iron, cobalt, ruthenium, or a mixture thereof.

3. The catalyst of claim 1, wherein the organic solvent is benzyl ether, aromatic alcohol, pyrrolidone, or liquid paraffin.

4. The catalyst of claim 2, wherein the organic solvent is benzyl ether, aromatic alcohol, pyrrolidone, or liquid paraffin.

5. The catalyst of claim 1, wherein the grain size of the transition metal is between 5 and 20 nm.

6. The catalyst of claim 2, wherein the grain size of the transition metal is between 5 and 20 nm.

7. A method for preparing a catalyst, the method comprising:
1) dissolving an organic salt of a transition metal in an organic solvent comprising a polyhydric alcohol, to yield a mixture; and
2) heating and stiffing the mixture in the presence of air or inert gas, holding the mixture at a temperature of between 150 and 250° C. for between 30 and 240 min, to yield the catalyst.

8. The method of claim 7, wherein in 1), the transition metal is manganese, iron, cobalt, ruthenium, or a mixture thereof, and the organic salt is an oxalate, acetylacetonate, or carbonyl metal salt.

9. The method of claim 7, wherein in 1), the polyhydric alcohol is C₃-C₁₈ dihydric alcohol or trihydric alcohol, and the organic solvent is benzyl ether, aromatic alcohol, pyrrolidone, or liquid paraffin.

10. The method of claim 8, wherein in 1), the polyhydric alcohol is C₃-C₁₈ dihydric alcohol or trihydric alcohol, and the organic solvent is benzyl ether, aromatic alcohol, pyrrolidone, or liquid paraffin.

11. The method of claim 7, wherein in 1), a molar ratio of the polyhydric alcohol to the organic salt of the transition metal is between 1-5:1, and a molar ratio of the organic solvent to the organic salt of the transition metal is between 30-500:1.

12. The method of claim 8, wherein in 1), a molar ratio of the polyhydric alcohol to the organic salt of the transition metal is between 1-5:1, and a molar ratio of the organic solvent to the organic salt of the transition metal is between 30-500:1.

13. The method of claim 7, wherein in 2), a heating rate of the mixture is between 1 and 10° C./min, and a holding time of the temperature is between 60 and 120 min

14. The method of claim 8, wherein in 2), a heating rate of the mixture is between 1 and 10° C./min, and a holding time of the temperature is between 60 and 120 min

15. A method for Fischer-Tropsch synthesis, the method comprising applying the catalyst of claim 1 to a feed of hydrogen and carbon monoxide, and controlling a reaction temperature of between 180 and 300° C., a reaction pressure of between 1 and 3 megapascal, a feed volume ratio of the hydrogen to the carbon monoxide of between 1 and 2.5, and a total space velocity of between 0.5 and 15 L/h/g catalyst.
